(19) United States
(12) Patent Application Publication
(10) Pub. No.: US 2009/0322542 A1
(43) Pub. Date: Dec. 31, 2009

(54) SYSTEM AND METHOD FOR MONITORING AMBIENT TEMPERATURE AND HUMIDITY

(75) Inventors: HONG-LIANG DING, Shenzhen City (CN); LI-XIA PENG, Shenzhen City (CN); XIAO-HUI CHANG, Shenzhen City (CN); YONG-GANG ZHANG, Shenzhen City (CN); KUANG-YUAN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/436,717

(22) Filed: May 6, 2009

(30) Foreign Application Priority Data
Jun. 26, 2008 (CN) 200810302333.4

(51) Int. Cl. G08B 17/00

(52) U.S. Cl. 340/588

(57) ABSTRACT

A system and method for ambient monitoring temperature and humidity, includes a controller, a host and an alarm device. The controller includes a sensing module and a determining module. The sensing module senses temperature and humidity. The determining module determines whether the sensed environment temperature and humidity are abnormal according to predetermined standards, and determines howl long the environment continues to be abnormal, and outputs an abnormal signal if the abnormal environment continues to be abnormal beyond a preset time limit. The host is connected to the controller, to transmit an alarm signal according to the abnormal signal. The alarm device is connected to the host, to activate according to the alarm signal.

### BACKGROUND

1. Technical Field

The present disclosure relates to a system and method for monitoring ambient temperature and humidity.

2. Description of Related Art

With the development of sensing technology and network communication technology, an intelligent controller integrated with a sensing function, a computation function and a communication function is widely used. The intelligent controller can sense and process environmental parameters, such as temperature, humidity and so on, and then communicate with other devices via a network to transmit the environmental parameters to users. Thus, the environment can be timely monitored by the intelligent controller instead of humans.

### BRIEF DESCRIPTION OF THE DRAWINGS

FIG. 1 is an application environment of a system for monitoring ambient temperature and humidity of one embodiment of the present disclosure;

FIG. 2 is a block diagram of a controller of FIG. 1;

FIG. 3 is a block diagram of a host of FIG. 1; and

FIG. 4 is a flowchart of a method for monitoring ambient temperature and humidity.

### DETAILED DESCRIPTION

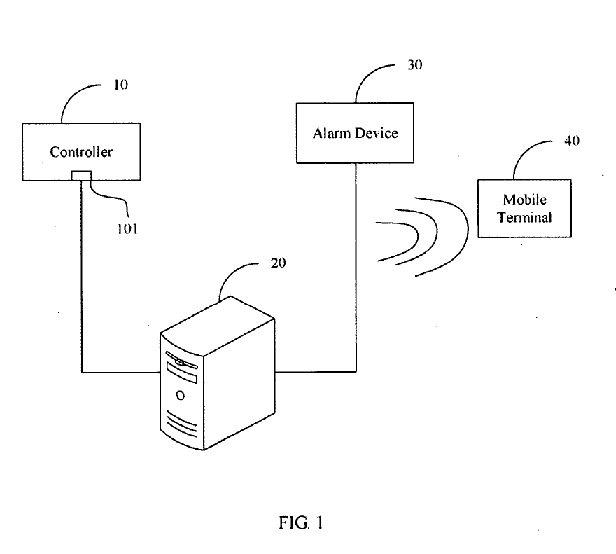

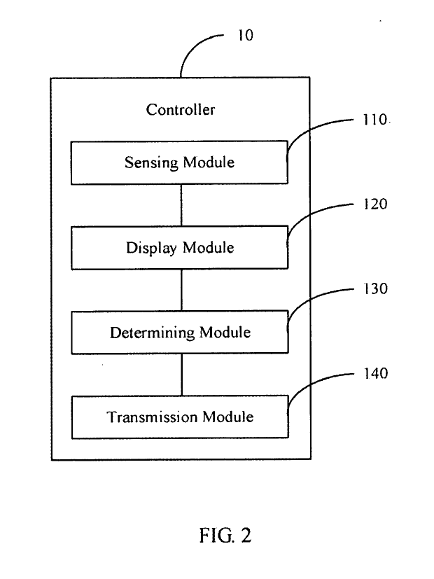

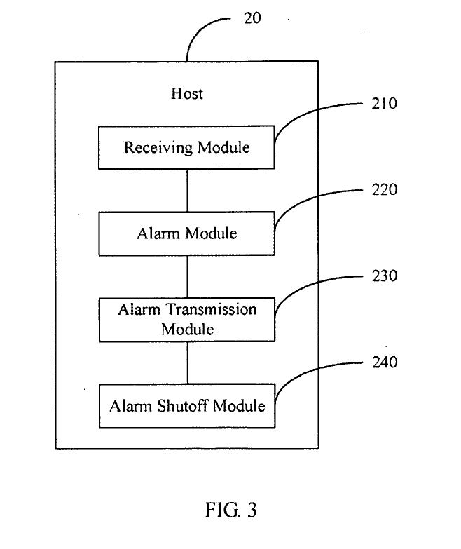

FIG. 1 is an application environment of one embodiment of the present disclosure of a system for monitoring ambient temperature and humidity, which comprises a controller 10, a host 20, an alarm device 30, and a mobile terminal 40. The alarm device 30 may be a flashing lamp, for example. The controller 10 has a network interface 101. Also referring to FIG. 2 and FIG. 3, FIG. 2 is a block diagram of the controller 10 and FIG. 3 is a block diagram of the host 20.

In one embodiment, the controller 10 is placed in an environment that needs to be monitored, such as a computer room, and comprises a sensing module 110, a display module 120, a determining module 130 and a transmission module 140. The sensing module 110 senses temperature and humidity of the computer room, and outputs the sensed temperature and humidity. The display module 120 controls a display panel (not shown) that is outside of the controller 10 to show the sensed temperature and humidity. The determining module 130 determines whether the sensed temperature and humidity are abnormal according to predetermined standards. In one embodiment, the predetermined standards comprise a predetermined ambient temperature range and a predetermined ambient humidity range. In other words, the determining module determines whether the sensed temperature is in the predetermined ambient temperature range, such as 20˜25° C., and whether the sensed humidity is in the predetermined ambient humidity range, such as 40%˜60%. If the sensed temperature and humidity are respectively in the predetermined ambient temperature range and the predetermined ambient humidity range, the system determines that the environment is normal and continues checking the ambient temperature and humidity. If the sensed temperature is not in the predetermined ambient temperature range and/or the sensed humidity is not in the predetermined ambient humidity range, the determining module 130 determines that the environment is abnormal and determines how long the environment continues to be abnormal. If the abnormal environment continues to be abnormal beyond a preset time limit, such as five minutes, then the determining module 130 outputs an abnormal signal to the transmission module 140. Then, the transmission module 140 transmits the abnormal signal to the host 20 via the network interface 101.

The host 20, placed in a remote monitoring center different from the computer room, is connected to the alarm device 30, which comprises a receiving module 210, an alarm module 220, an alarm transmission module 230, and an alarm shutoff module 240. In the host 20, the receiving module 210 receives the abnormal signal. The alarm module 220 outputs an alarm signal, and triggers the alarm device 30 to activate in order to notify operators to take action to correct the abnormal environment. In addition, the alarm transmission module 230 transmits messages to mobile terminals 40, such as mobile phones or computers, of correlative people, such as engineers and management personnel. In one embodiment, the messages comprise short messages or electronic mails (e-mails). Once the abnormal environment has been corrected, the operators can then press an alarm shutoff button (not shown) on a panel of the host 30. The receiving module 210 receives an alarm shutoff signal, and then the alarm shutoff module 240 deactivates the alarm signal output from the alarm module 220, and the alarm device 30 is turned off. In one embodiment, the determining module 130 also determines whether the abnormal environment has been corrected to be within the predetermined ambient temperature and the predetermined ambient humidity range.

Alternatively, the alarm device 30 may be other than a flashing lamp, such as an alarm bell.

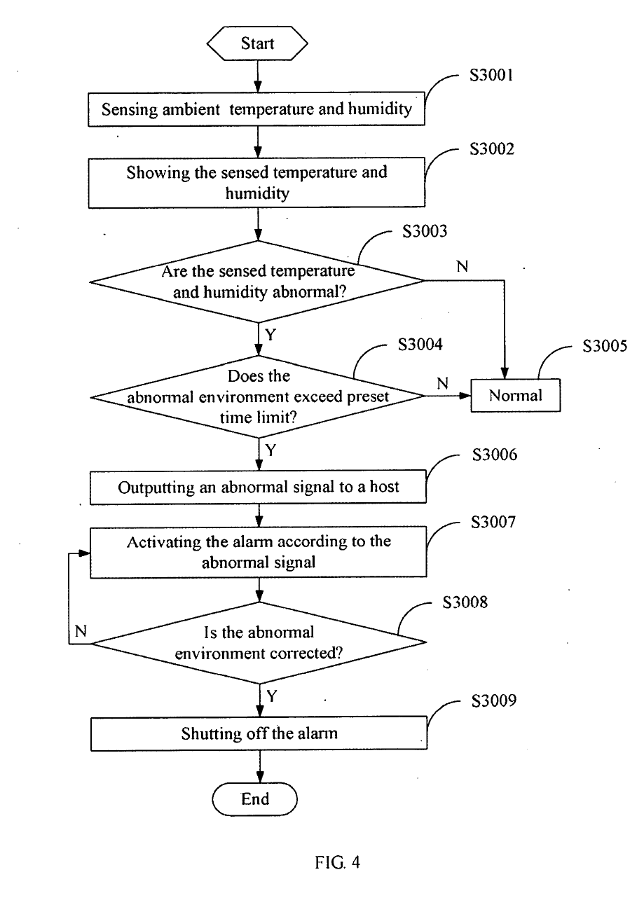

FIG. 4 is a flowchart of a method for monitoring ambient temperature and humidity. In a step S3001, the sensing module 110 senses temperature and humidity of a computer room. In a step S3002, the display module 120 shows the sensed temperature and humidity. In a step S3003, the determining module 130 determines whether the sensed temperature and humidity are abnormal according to the predetermined standards, namely, determines whether the sensed temperature is in the predetermined ambient temperature range, and whether the sensed humidity is in the predetermined ambient humidity range. If the sensed temperature and humidity are normal, return to step S3001.

If the sensed temperature and humidity are abnormal, execute step S3004, in which the determining module 130 continues determining whether the abnormal environment continues to be abnormal beyond a preset time limit. If the abnormal environment does not continue beyond the preset time limit, return to step S3001. In one embodiment, the step S3004 is executed to make sure the abnormal environment is not an instantaneous fluctuation.

If the abnormal environment continues beyond the preset time limit, execute a step S3006, the transmission module 140 transmits the abnormal signal output from the determining module 130 to the host 20 via the network interface 101.

In a step S3007, when the receiving module 210 of the host 30 receives the abnormal signal, the alarm module 220 outputs an alarm signal and activates the alarm. Here, the alarm comprises activating the alarm device 30 and transmitting short messages or e-mails to the mobile terminals of the correlative people. In a step S3008, the determining module 130 determines whether the abnormal environment has been corrected to be within the predetermined standards.

If the abnormal environment continues, return to the step S3007. If the abnormal environment has been corrected to be within the predetermined standards, execute a step S3009, the operators manually shuts off the alarm.

In one embodiment, the system utilizes a step by step alarming manner. Namely, in a preset time, if an abnormal environment has not been corrected, the alarm module 230 reports the abnormal environment to managers via short messages or e-mails until the alarm condition is corrected and/or the alarm shut off.

In the present invention, the system utilizes the controller 10 and the host 20 to remotely monitor environmental conditions of the computer room. Thus, conditions such as the temperature and humidity can be managed timely and effectively.

Although the features and elements of the present disclosure are described in various inventive embodiment in particular combinations, each feature or element can be configured alone or in various within the principles of the present disclosure to the full extent indicated by the broad general meaning of the terms in which the appended claims are expressed.

What is claimed is:

1. A system for monitoring ambient temperature and humidity, comprising:
a controller, comprising:
a sensing module to sense ambient temperature and humidity of a closed environment; and
a determining module to determine whether the sensed temperature and humidity are abnormal according to predetermined standards, and further to determine how long the environment continues to be abnormal, and to output an abnormal signal if the abnormal environment continues to be abnormal beyond a preset time limit;
a host connected to the controller, to transmit an alarm signal according to the abnormal signal; and
an alarm device connected to the host, to be activated according to the alarm signal.

2. The system as claimed in claim 1, wherein the controller comprises:
a display module to show the sensed temperature and humidity; and
a transmission module to transmit the abnormal signal to the host.

3. The system as claimed in claim 1, wherein the controller comprises a network interface structured and arranged to connect the host to the controller.

4. The system as claimed in claim 1, wherein the predetermined standards comprise a predetermined ambient temperature range and a predetermined ambient humidity range.

5. The system as claimed in claim 4, wherein the determining module further determines whether the abnormal environment has been corrected to be within the predetermined ambient temperature range and the predetermined ambient humidity range.

6. The system as claimed in claim 1, wherein the host comprises:
a receiving module to receive the abnormal signal;
an alarm module to output an alarm signal according to the abnormal signal;
an alarm transmission module to transmit messages to correlative people according to the alarm signal; and
an alarm shutoff module to deactivate the alarm signal after the abnormal environment has been corrected.

7. The system as claimed in claim 6, further comprising mobile terminals to receive the messages.

8. The system as claimed in claim 7, wherein the messages are short messages or electronic mails.

9. The system as claimed in claim 1, wherein the alarm device is a flashing lamp.

10. A method for monitoring ambient temperature and humidity, comprising:
sensing ambient temperature and humidity of a closed environment;
determining whether the sensed temperature and humidity are abnormal according to predetermined standards;
determining the abnormal environment continues to be abnormal beyond a preset time limit, if the sensed temperature and humidity are abnormal;
determining whether the abnormal environment has been corrected to be within the predetermined standards; and
shutting off the alarm, if the abnormal environment has been corrected to be within the predetermined standards.

11. The method as claimed in claim 10, further comprising displaying the sensed temperature and humidity on a display.

12. The method as claimed in claim 10, further comprising checking the temperature and humidity continues, if the sensed temperature and humidity are normal.

13. The method as claimed in claim 10, further comprising continuing to check the temperature and humidity, if the abnormal environment does not continue to be abnormal beyond the preset time limit.

14. The method as claimed in claim 10, further comprising setting an alarm to alarm continuously, if the abnormal environment has not been corrected to be within the predetermined standards.

15. The method as claimed in claim 10, wherein the predetermined standards comprises a predetermined ambient range and a predetermined ambient humidity range.
